(19) United States
(12) Patent Application Publication
(10) Pub. No.: US 2025/0287854 A1
(43) Pub. Date: Sep. 18, 2025

(54) METHOD FOR IDENTIFYING A GROUND-PENETRATING ACCESSORY ON AN AGRICULTURAL TRACTOR

(71) Applicant: DEERE & COMPANY, MOLINE, IL (US)

(72) Inventors: Benedikt Peters, Grünstadt (DE); Lucas Schreieck, Hassloch (DE)

(21) Appl. No.: 19/058,103

(22) Filed: Feb. 20, 2025

(30) Foreign Application Priority Data
Mar. 13, 2024 (EP) 24163183.7

(51) Int. Cl. A01B 59/06

(52) U.S. Cl. CPC A01B 59/069; A01B 59/066

(57) ABSTRACT

A method for identifying a ground-penetrating accessory on an agricultural tractor which has a rear three-point power lift having left and right lower links supported at lower securing locations of the three-point power lift to be pivoted vertically and raised and lowered by a lifting mechanism, includes measuring via a sensor arrangement a tensile force occurring on one or more of the left and right lower links, and drawing via a control unit a conclusion relating to a ground-penetrating accessory which is attached to the lower links when it identifies that the tensile force path when the lower links are raised approaches a static negative value.

### CROSS-REFERENCE TO RELATED APPLICATIONS

This application claims priority to European Patent Application No. 24163183.7, filed Mar. 13, 2024, which is hereby incorporated by reference.

### FIELD OF THE DISCLOSURE

The disclosure relates to a method for identifying a ground-penetrating accessory on an agricultural tractor.

### BACKGROUND

Agricultural implements can be attached to a three-point hitch of an agricultural tractor. The three-point hitch can raise and lower the attached agricultural implement.

### SUMMARY

The disclosure relates to a method for identifying a ground-penetrating accessory on an agricultural tractor which has a rear three-point power lift having left and right lower links which are supported at lower securing locations of the three-point power lift so as to be able to be pivoted vertically and which can be raised and lowered by means of a lifting mechanism, wherein at least at one of the lower securing locations there is provided a sensor arrangement by means of which a tensile force which occurs on the lower link is established.

The tensile force information items provided by the sensor arrangement typically form the basis for the implementation of a tensile force control which adapts the working depth of a ground-penetrating accessory, such as, for example, a plough, a harrow, or a cultivator depending on the ground structure or density. The sensor arrangement is generally a force measurement pin which is an integral component of a bearing of the lower link within the securing location of the three-point power lift.

Although the presence of a tensile force signal produced by the force measurement pin may indicate the presence of a ground-penetrating accessory on the three-point power lift, it only does so with the appearance of corresponding tensile forces, that is to say, when the ground processing has already begun. A more extensive identification of a ground-penetrating accessory on the three-point power lift for universal purposes is thus not possible.

An object of the present disclosure is to universally expand a method of the type mentioned in the introduction with regard to the identification of a ground-penetrating accessory which is attached to the three-point power lift.

This object is achieved with a method for identifying a ground-penetrating accessory on an agricultural tractor having the features of one or more of the embodiments disclosed herein.

In a method for identifying a ground-penetrating accessory on an agricultural tractor, the agricultural tractor has a rear three-point power lift having left and right lower links which are supported at lower securing locations of the three-point power lift so as to be able to be pivoted vertically and which can be raised and lowered by means of a lifting mechanism, wherein at least at one of the lower securing locations there is provided a sensor arrangement by means of which a tensile force which occurs on the lower link is established. In this instance, a control unit (e.g., a controller including a processor and memory) draws a conclusion relating to a ground-penetrating accessory which is attached to the lower links when it identifies that the tensile force path approaches a static negative value ΔF when the lower links are raised.

This procedure makes use of the observation that the tensile force acting on the lower securing locations when the lower links are lowered from a raised transport position until the ground-penetrating processing tools come into contact with the subsoil maintains a substantially static or constant negative value ΔF in order to continuously rise when the agricultural tractor is driven forwards with increasing penetration into the subsoil as a result of the opposing ground resistance.

The substantially static or constant negative value ΔF observed in the tensile force path is in this instance brought about by the weight force proportions of the accessory acting in the raised transport position via the lower links in the direction of the lower securing locations.

This information can be used universally in so far as this for example permits a conclusion regarding accessory-related changing mass relationships on the agricultural tractor or three-point power lift and consequently can be incorporated into methods for ballasting or active vibration damping of the agricultural tractor. The latter includes an active front axle suspension, but also a vibration absorber brought about by connecting lifting movements in phase opposition on the three-point power lift, as described, for example, in DE 10 2016 224 753 A1. The accessory acts in this case as an absorption mass. A configuration menu, which can be selected by means of a Graphical User Interface (GUI), of a tensile force control of the agricultural tractor can also be automatically activated. When there is no ground-penetrating accessory present, this may be inactive or greyed out on the Graphical User Interface.

Furthermore, for the transition point observed in the tensile force path between the static or constant negative value ΔF and the tensile force increase introduced, the respective lifting position pb of the lower links is detected and stored as a zero spacing of the ground-penetrating processing tools for the relevant accessory. Based on this reference value, for example, a vertical spacing control of the ground-penetrating processing tools in order to flatten or smooth a subsoil contour is conceivable.

Advantageous further developments of the method according to the disclosure will be appreciated from the one or more of the embodiments disclosed herein.

For example, it is possible for the control unit, depending on the value of the static negative value ΔF which occurs to conclude a specific accessory category. The categorization can inter alia be carried out with regard to the mass and/or position of center of gravity of the accessory so that in this regard a further specification of the mass relationships which can benefit the above-mentioned applications for active vibration damping is possible.

Conversely, the control unit can reliably conclude that a decoupling operation of the ground-penetrating accessory has been carried out when the static negative value ΔF approaches zero when a stoppage of the agricultural tractor has been identified when the lower links are lowered and remains unchanged when the agricultural tractor is subsequently started up again.

The above and other features will become apparent from the following detailed description and accompanying drawings.

### BRIEF DESCRIPTION OF THE DRAWINGS

The method according to the disclosure will be explained in more detail hereinafter on the basis of the appended drawings, in which:

FIG. 1 shows an arrangement which is illustrated as a block diagram for carrying out the method according to the disclosure for identifying a ground-penetrating accessory on an agricultural tractor;

FIG. 2 shows a rear view of the three-point power lift on the agricultural tractor according to FIG. 1; and

FIG. 3 shows an example tensile force path depending on the lifting position of the three-point power lift with an attached ground-penetrating accessory in the form of a plough.

### DETAILED DESCRIPTION

The embodiments or implementations disclosed in the above drawings and the following detailed description are not intended to be exhaustive or to limit the present disclosure to these embodiments or implementations.

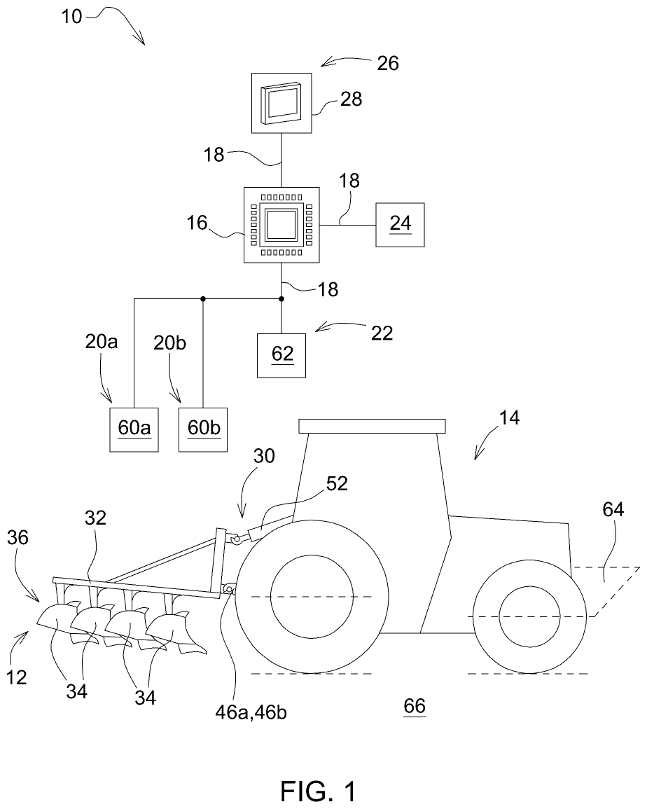

FIG. 1 shows an arrangement 10 which is illustrated as a block diagram and with reference to which the function of the method according to the disclosure for identifying a ground-penetrating accessory 12 on an agricultural tractor 14 is intended to be explained.

The arrangement 10 located in the agricultural tractor 14 comprises a microprocessor-controlled control unit 16 which communicates via a CAN databus 18 with a first sensor arrangement 20a, a second sensor arrangement 20b, a third sensor arrangement 22, a local data store 24 and a Graphical User Interface 26 (GUI) in the form of a touch-sensitive display 28.

A three-point power lift 30 which is provided at the rear of the agricultural tractor 14 serves to attach inter alia accessories and additional devices for ground processing, for example, the ground-penetrating accessory 12 in the form of a plough 32 (or plow) having a large number of ground-penetrating processing tools 34 which are in the form of ploughshares 36 (or plowshares).

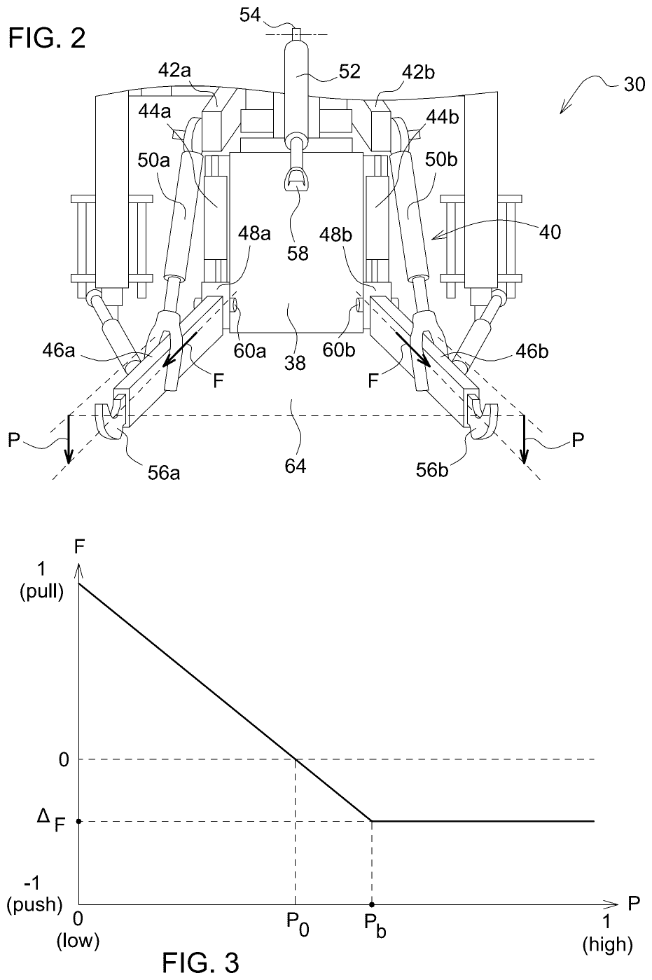

The three-point power lift 30 which is arranged on a differential housing 38 of the agricultural tractor 14 is shown in detail in FIG. 2 from the rear. It is of conventional form and comprises a hydraulically actuatable lifting mechanism 40 with left and right lifting arms 42a, 42b which can be raised and lowered by means of associated hydraulic cylinders 44a, 44b, and left and right lower links 46a, 46b which are supported at lower securing locations 48a, 48b of the three-point power lift 30 so as to be able to be pivoted vertically and are movingly connected by means of longitudinally adjustable lifting struts 50a, 50b to the lifting arms 42a, 42b. Furthermore, a central upper link 52 which is suspended at an upper securing location 54 of the three-point power lift 30 so as to be able to be vertically pivoted is provided. Both the lower links 46a, 46b and the upper link 52 have releasable coupling hooks 56a, 56b, 58 for receiving complementary coupling elements (not illustrated) on the ground-penetrating accessory 12.

The first and second sensor arrangements 20a, 20b are first and second force measurement pins 60a, 60b which are an integral component of a respective bearing of the lower links 46a, 46b within the lower securing locations 48a, 48b of the three-point power lift 30. Consequently, at each of the two lower securing locations 48a, 48b there is provided a separate force measurement pin 60a, 60b which enables a tensile force F which occurs on the lower links 46a, 46b to be established. Alternatively, only one of the two sensor arrangements 20a, 20b and consequently only one of the force measurement pins 60a, 60b may also be used. The third sensor arrangement 22 is in the form of a position sensor 62 and serves to detect the current lifting position p of the lower links 46a, 46b with respect to a defined reference plane 64 which is fixed with respect to the tractor. In FIG. 2, the two lower links 46a, 46b are illustrated by way of example in a lifting position p which is lowered with respect to that of the reference plane 64.

The method according to the disclosure is started by the control unit 16 when the agricultural tractor 14 is started up. The control unit 16 subsequently continuously establishes based on the data items, which are provided via the CAN databus 18, of the sensor arrangements 20a, 20b, 22 the tensile force F depending on the current lifting position p of the lower links 46a, 46b and consequently the tensile force path F(p). In this instance, the control unit 16 draws a conclusion relating to a ground-penetrating accessory 12 attached to the lower links 46a, 46b when it identifies that the established tensile force path (F) p approaches a static negative value ΔF when the lower links 46a, 46b are raised.

This behavior is depicted by way of example in FIG. 3 for the plough 32 which is attached to a three-point power lift 30, wherein the tensile force F and lifting position p are in each case standardized to one. As can be seen, the tensile force F acting at the lower securing locations 48a, 48b when the lower links 46a, 46b are lowered from a raised transport position until the ploughshares 34 come into contact with the subsoil 66 maintains a substantially static or constant negative value ΔF in order to continuously rise as the ploughshares 34 penetrate further into the subsoil 66 as a result of the opposing ground resistance during forward travel of the agricultural tractor 14.

The substantially static or constant negative value ΔF observed in the tensile force path F(p) is in this instance brought about by the weight force portions of the plough 32 acting in the transport position which is raised beyond a neutral position p0 via the lower links 46a, 46b in the direction of the lower securing locations 48a, 48b.

In addition, the control unit 16 depending on the value of the static or constant negative value ΔF occurring concludes a specific accessory category. The categorization is carried out inter alia with regard to the mass and/or center of gravity of the ground-penetrating accessory 12 so that in this regard further specification of the mass relationships is possible. The corresponding associations are saved in the local data store 24 and can be called up at that location by the control unit 16.

These information items can be used universally in so far as they permit a conclusion relating to accessory-related mass relationship changes on the agricultural tractor 14 or three-point power lift 30 and consequently can be incorporated in methods for ballasting or active vibration-damping of the agricultural tractor 14. The latter includes an active front axle suspension but also a vibration absorber which is implemented by connecting lifting movements in phase opposition on the three-point power lift 30, as described, for example, in DE 10 2016 224 753 A1. The accessory 12 acts in this instance as a vibration damper. A configuration menu, which can be selected via the Graphical User Interface 26 or the display 28 thereof, of a tensile force control of the agricultural tractor 14 can also be automatically activated. If there is no ground-penetrating accessory 12 present, this may be inactive or greyed out in the Graphical User Interface 26 or the display 28 thereof.

Furthermore, the control unit 16 detects, for the transition point observed in the tensile force path F(p) between a static or constant negative value ΔF and tensile force increase which occurs, the respective lifting position pb of the lower links 46a, 46b (see in this regard FIG. 3) and stores it as a zero spacing of the ground-penetrating processing tools 36 for the relevant accessory 12 in the local data store 24. Based on this reference value, for example, there is a vertical spacing control of the ground-penetrating processing tools 36 for levelling or smoothing a subsoil contour.

Conversely, the control unit 16 concludes that a decoupling operation of the ground-penetrating accessory 12 has been carried out when the static negative value ΔF approaches zero when a stoppage of the agricultural tractor 14 has been detected when the lower links 46a, 46b are lowered and remains unchanged when starting up subsequently.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A method for identifying a ground-penetrating accessory on an agricultural tractor which has a rear three-point power lift having left and right lower links supported at lower securing locations of the three-point power lift to be pivoted vertically and raised and lowered by a lifting mechanism, comprising:
measuring via a sensor arrangement a tensile force occurring on one or more of the left and right lower links; and
drawing via a control unit a conclusion relating to a ground-penetrating accessory which is attached to the lower links when it identifies that the tensile force path when the lower links are raised approaches a static negative value.

2. The method according to claim 1, wherein the control unit concludes a specific accessory category depending on the value of the static negative value.

3. The method according to claim 1, wherein the control unit concludes that a decoupling operation of the ground-penetrating accessory has been carried out when the static negative value approaches zero when a stoppage of the agricultural tractor has been identified when the lower links are lowered and remains unchanged when the agricultural tractor is subsequently started up.

4. A system for identifying a ground-penetrating accessory on an agricultural tractor which has a rear three-point power lift having left and right lower links supported at lower securing locations of the three-point power lift to be pivoted vertically and raised and lowered by a lifting mechanism, comprising:
a sensor arrangement at one or more of the lower securing locations configured to measure a tensile force occurring on one or more of the left and right lower links; and
a control unit configured to draw a conclusion relating to a ground-penetrating accessory which is attached to the lower links when it identifies that the tensile force path when the lower links are raised approaches a static negative value.

5. The system according to claim 4, wherein the control unit is configured to conclude a specific accessory category depending on the value of the static negative value.

6. The system according to claim 4, wherein the control unit is configured to conclude that a decoupling operation of the ground-penetrating accessory has been carried out when the static negative value approaches zero when a stoppage of the agricultural tractor has been identified when the lower links are lowered and remains unchanged when the agricultural tractor is subsequently started up.
